(19) United States
(12) Patent Application Publication
(10) Pub. No.: US 2023/0334598 A1
(43) Pub. Date: Oct. 19, 2023

(54) ON GRID/OFF GRID UTILITY KIOSK

(71) Applicant: April Jennesis-Collet, Kalamazoo, MI (US)

(72) Inventor: April Jennesis-Collet, Kalamazoo, MI (US)

(21) Appl. No.: 17/722,517

(22) Filed: Apr. 18, 2022

(51) Int. Cl. G06Q 50/06; E03B 7/09; H02J 9/06; G06Q 30/06; G06Q 20/18

(52) U.S. Cl. CPC G06Q 50/06; E03B 7/095; H02J 9/068; H02J 9/066; G06Q 30/0641; G06Q 20/18; E03F 5/10

(57) ABSTRACT

A utility provisioning station for providing utility services to a consumer. The utility provisioning station includes a power supply, a water storage tank, a sewage storage tank, a communications module, an ecommerce interface, and a controller. The power supply supplies electrical power service to the consumer. The water storage tank retains and supplies water service to the consumer. The sewage storage tank provides wastewater services by receiving and retaining wastewater from the consumer. The communications module provides telecommunications services to the consumer. The ecommerce interface receives requests for selected utility services. The controller controls the power supply, the water storage tank, the sewage storage tank, and the communications module, and directs the selected utility services to be provided to the consumer.

### FIELD OF THE INVENTION

The present invention is directed to the supply of utilities, and in particular, to supplying utilities to consumers.

### BACKGROUND OF THE INVENTION

Conventional utility services (water, sewer, electrical, and telecommunication, etc.) are traditionally associated with fixed locations. For example, utility services are commonly associated with permanent buildings (e.g., residences and commercial businesses) as well as fixed locations for temporary services (e.g., recreational vehicle parks and truck stops).

Embodiments of the present invention provide methods and systems for providing utility services to consumers. An exemplary utility kiosk may be arranged as a self-contained system (“off-grid”) or configured to couple to publicly provided utilities (e.g., water, sewer, and electric). Alternatively, the utility kiosk may be configured as a hybrid system with some utilities provided internally (e.g., a self-contained water tank with potable water and a self-contained storage tank for receiving and storing grey water/black water), while other utilities are provided by public utilities (e.g., electricity). The utility kiosk also includes an e-commerce module allowing the consumer to purchase selected utility from a particular utility kiosk. The utility kiosk also includes a communications module for communicating with a central communications interface for coordinating reservations by consumers, and scheduling utility provisioning requests to utility providers.

A utility provisioning system for providing utility services to a consumer in accordance with an embodiment of the present invention, which includes at least one of a power supply, a water storage tank, and a sewage storage tank. The system also includes a communications module, an ecommerce interface, and a controller. The power supply supplies electrical power service to the consumer. The water storage tank retains and supplies water service to the consumer. The sewage storage tank provides wastewater services by receiving and retaining wastewater from the consumer. The communications module provides telecommunications services to the consumer. The ecommerce interface receives requests for selected utility services. The controller controls the power supply, the water storage tank, the sewage storage tank, and the communications module, and directs the selected utility services to be provided to the consumer.

A utility kiosk interface system for coordinating a supply of utility services from a plurality of utility kiosks to a plurality of requesting consumers, which includes a plurality of utility kiosks, a communications module, and a plurality of utility providers. Each of the utility kiosks is configured to provide one or more utility services. The communications module is communicatively coupled to each of the plurality of utility kiosks, the communications module including a network interface for communicatively coupling to a plurality of consumers, and a controller managing communications between the plurality of consumers and the plurality of utility kiosks. The plurality of utility providers each provide at least one utility service to at least one of the utility kiosks. The communications module manages utility service requests and/or utility reprovision requests from one or more utility kiosks to the plurality of utility providers. The communications module also manages utility service requests from any one or more of the plurality of requesting consumers, and managing the reservation of utility services from a particular utility kiosk for a particular consumer.

In an aspect of the present invention, the consumer is one of a recreational vehicle, a temporary residence, and emergency service vehicles.

In another aspect of the present invention, the power supply includes an energy storage module including at least one battery. Alternatively, the power supply includes one of a solar panel array and/or a generator for producing electrical power and to supply electrical power to the energy storage module.

In a further aspect of the present invention, the water storage tank includes a water pump configured to selectively pump the water from the water storage tank to the consumer. The sewage storage tank includes a wastewater pump selectively pumping wastewater from the consumer to the sewage storage tank.

In another aspect of the present invention, the telecommunications services include telephonic services and/or Internet access. The ecommerce interface also receives electronic payment as part of a request for selected utility services.

In a further aspect of the present invention, the utility kiosk includes one of: a utility provisioning device arranged as a self-contained system (“off-grid”), a utility provisioning device coupled to publicly provided utilities (“on-grid”), and a utility provisioning device configured as a hybrid system with some utility services provided internally (“off-grid”), while other utility services are provided by public utilities (“on-grid”).

In another aspect of the present invention, the utility services include at least one of: a power supply configured to supply electrical power service to the consumer; a water storage tank configured to retain water and supply water service to the consumer; and a sewage storage tank configured to provide wastewater services by receiving and retaining wastewater from the consumer.

In a further aspect of the present invention, the communications module includes a network interface configured to communicatively couple the communications module to the consumers, the utility kiosks, and the utility providers. The network interface includes telecommunications hardware including at least one of cellular telecommunications hardware for communicatively coupling to a cellular network, satellite telecommunications hardware for communicatively coupling to a satellite communications network, landline telephone technology, and Internet connections.

These and other objects, advantages, purposes, and features of the present invention will become apparent upon review of the following specification in conjunction with the drawings.

### BRIEF DESCRIPTION OF THE DRAWINGS

FIG. 1 is a block diagram of an exemplary off-grid utility provisioning station for supplying a variety of utilities to a consumer in accordance with the present invention;

FIG. 2 is a block diagram of the off-grid utility provisioning station of FIG. 1 with a fuel-powered generator;

FIG. 3 is a block diagram of an exemplary on-grid utility provisioning station for supplying a variety of utilities to a consumer in accordance with the present invention;

FIG. 4 is a block diagram of an exemplary self-contained utility provisioning station for supplying a variety of utility to a consumer in accordance with the present invention;

FIG. 5A is a block diagram of an exemplary utility interface with a security housing for the self-contained utility provisioning station of FIG. 4 in accordance with the present invention;

FIG. 5B is a block diagram of an alternative utility interface without a security housing for the self-contained utility provisioning station of FIG. 4 in accordance with the present invention;

FIG. 5C is a block diagram of an exemplary kiosk interface for interacting with the kiosk system and executing customer or client transactions in accordance with the present invention; and

FIG. 6 is a block diagram of an exemplary utility kiosk network interface providing consumer reservations and utility resupply in accordance with the present invention.

These and other objects, advantages, purposes, and features of the present invention will become apparent upon review of the following specification in conjunction with the drawings.

### DESCRIPTION OF THE PREFERRED EMBODIMENTS

Referring to the drawings and the illustrative embodiments depicted therein, a utility provisioning station provides a variety of utilities to a consumer, e.g., a recreational vehicle or temporary residence. The utility provisioning station (also known as a utility kiosk) is configured as a self-contained system (“off-grid”) or configured to couple to publicly provided utilities (e.g., water, sewer, and electrical). Alternatively, the utility kiosk is configured as a hybrid system with some utilities provided internally (e.g., self-contained water tank with potable water and a self-contained storage tank for receiving and storing grey water/black water), while selected other utilities are provided via a public utility connection (e.g., electricity). The utility kiosk also includes an e-commerce module to allow a consumer to purchase selected utilities from a particular utility kiosk.

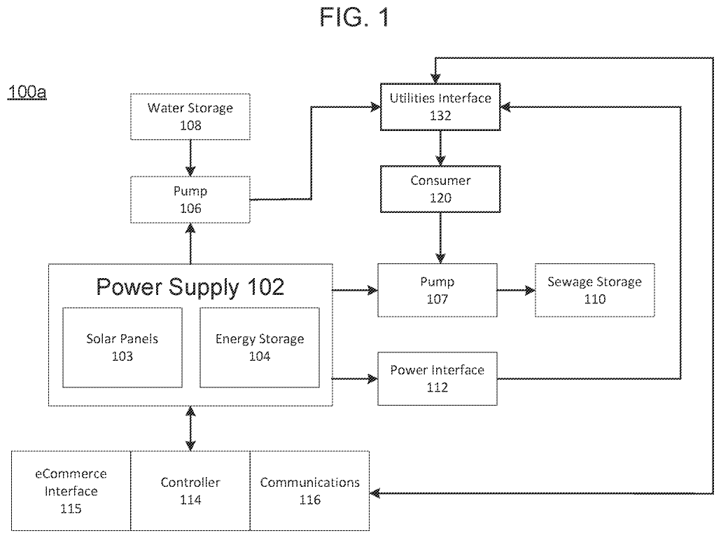

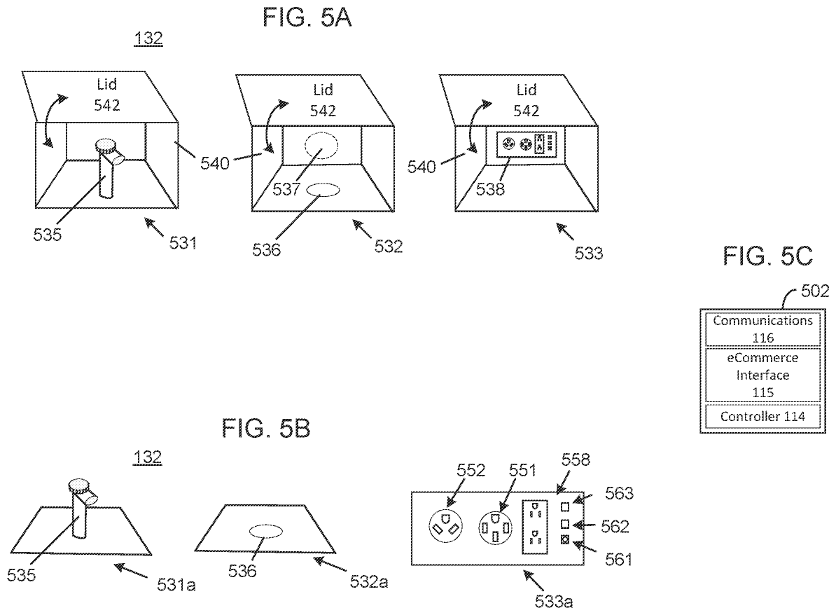

FIG. 1 illustrates a utility provisioning station 100a that is configured as a free-standing or off-grid system that provides utilities (via a secured utilities interface 132) to a consumer, such as a recreational vehicle or temporary residence away from conventional utilities. A power supply 102 includes an arrangement of solar panels 103 providing electrical power to the power supply 102. The power supply 102 also includes an energy storage device 104, which includes an arrangement of batteries for storing electrical energy output by the solar panels 103. The power supply 102 is electrically coupled to a water pump 106 and a wastewater pump 107. The water pump 106 is coupled to a water storage tank 108 and is configured to pump water from the water storage tank 108 to a consumer 120 (e.g., a recreational vehicle or temporary residence), via the utilities interface 132. The wastewater pump 107 is coupled to a sewage storage tank 110 and is configured to pump wastewater from the consumer 120 to the sewage storage tank 110, via the utilities interface 132. The power supply 102 is also electrically coupled to a power interface 112 and a controller module 114. The power interface 112 is configured to provide a variety of different power output configurations (e.g., standard 110V ac outlets, 30A 110V ac outlets, 50A 220V ac outlets, and any variety of DC outlets) (see FIGS. 5A and 5B).

The controller 114 is communicatively coupled to each of the pumps (106, 107), the power interface, a communications module 116, and an eCommerce interface 115. In one embodiment, the ecommerce interface 115 and the communications module 116 are contained within the controller 114. In another embodiment, the ecommerce interface 115, the controller 114, and the communications module 116 are separate modules. The ecommerce interface 115 is configured to provide for the execution of financial transactions by the consumer 120 (via a mobile application or Internet based browser application) with the utility provisioning station 100a to purchase one or more utilities from the utility provisioning station 100a. The communications module 116 is configured to provide a variety of telecommunications services for the consumer 120. For example, the communications module 116 can provide Internet access with a variety of data plans, and/or provide telephone services, etc.

The water storage tank 108 is periodically refilled (e.g., by a water truck or similar delivery service), while the sewage storage tank 110 is periodically emptied (e.g., by a septic tank pumping tanker truck or similar service). The communications module 116 is coupled to a commercial telecommunications provider and/or an Internet provider via a network connection and/or a satellite link. The ecommerce interface 115 is electrically coupled to the controller 114 and the communications module 116 and is configured to communicatively couple to the consumer 120 via a wireless connection (e.g., Bluetooth, NFC (near field communication), and cellular network connection).

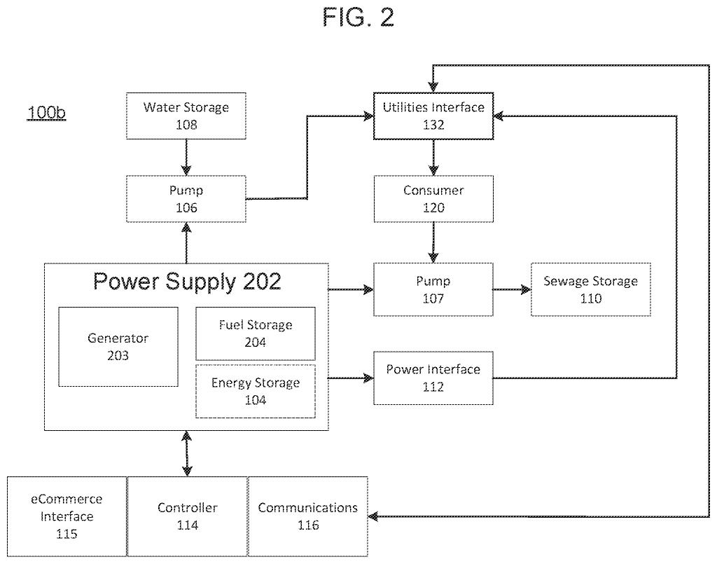

FIG. 2 illustrates a utility provisioning station 100b that is an alternative version of the utility provisioning station 100a. Instead of solar panels 103, the utility provisioning station 100b includes power supply 202 that includes a fuel-powered generator 203 and an internal fuel storage tank 204. In one embodiment, the generator 203 is a gasoline-fueled generator, or alternatively, a diesel-fueled generator (with the gasoline or diesel stored in the fuel storage tank 204). The power supply 202 also includes an energy storage module 104.

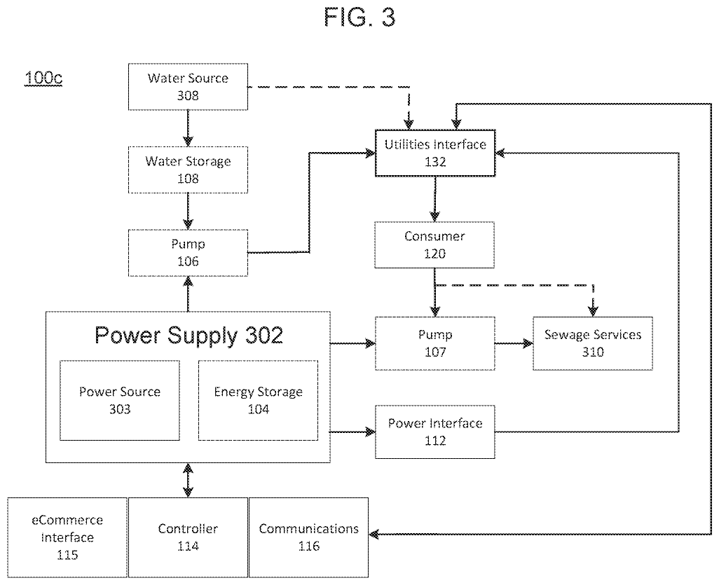

FIG. 3 illustrates a utility provisioning station 100c that is configured as a shore station or on-grid utility provisioning station. That is, the utility provisioning station 100c is coupled to a water source 308 (e.g., local/public water supply), sewage services 310 (e.g., sewer piping connecting to a local wastewater treatment plant), and a power supply 302 with a power source 303 (e.g., shore power or a local electrical utility provider) and an energy storage module 104. As illustrated in FIG. 3, the water source 308 refills the water storage tank 108, or alternatively, may be directly coupled to the consumer 120 (via the utilities interface 132) to supply water to the consumer 120. As also illustrated in FIG. 3, the wastewater from the consumer 120 is pumped (via the wastewater pump 107) to the sewage services 310, or alternatively, the wastewater from the consumer 120 is output directly to the sewage services 310. Similar to the utility provisioning stations 100a, 100b, illustrated in FIGS. 1 and 2, respectively, the consumer 120 is communicatively coupled to the communications module 116 and the ecommerce interface 115.

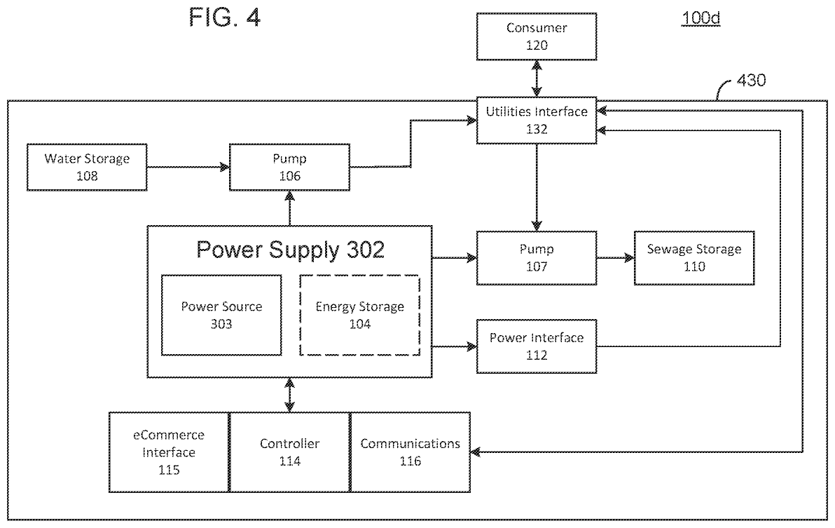

FIG. 4 illustrates a utility provisioning station 100d that includes the utility provisioning station 100a or 100b contained within a housing 430, and with a power supply 302 containing a power source 303 as described with respect to FIG. 3, and optionally, an energy storage module 104. The housing 430 also includes inlets/outlets for supplying/emptying the water storage tank 108 and the sewage storage tank 110, respectively. Thus, the utility provisioning station 100d is configured to be delivered to a location and coupled to either a power source, such as, shore power or a local electrical utility, or coupled to a temporary power source, such as a gas or diesel-fueled generator.

FIGS. 5A-5C illustrate a utilities interface 132 with an exemplary water interface 531, wastewater interface 532, and electrical interface 533 for coupling to the utilities provided by the utility provisioning station 100d. As illustrated in FIG. 5A, the water interface 531, wastewater interface 532, and electrical interface 533 may include a security housing 540. The controller 114 of the kiosk interface 502 controls access to the water interface 531, the wastewater interface 532, and the electrical interface 533 (via the security housing 540). FIG. 5A illustrates the security housing 540 with an open lid 542. While FIG. 5A illustrates separate security housings 540, a single housing 540 may be used. Further, two of the water interface 531, the wastewater interface 532, or the electrical interface 533 may use a single security housing 540 (with the remaining interface using a separate security housing 540). Alternatively, as illustrated in FIG. 5B, a water interface 531a, a wastewater interface 532a, and/or an electrical interface 533a are not housed within a security housing. Regardless of the embodiment (see FIG. 5A and 5B), access to the wastewater interface 532, 532a, the water interface 531, 531a, and the electrical interface 533, 533a may be controlled by the controller 114 (see FIG. 5C) via control valves, which are not accessible by the consumer 120. The water interface 531, 531a includes some sort of water faucet or connection point 535, used to provide potable water to the consumer 120. The wastewater interface 532, 532a includes an opening 536 for coupling the wastewater storage tanks of the consumer 120 to the wastewater storage tanks for facilities. The electrical interface 533, 533a includes an arrangement of electrical outlets on an electrical panel 558. As illustrated in FIG. 5A, the opening to the wastewater storage tanks is accessed either via an opening 536 in a ground-level facility or some other opening 537. Regardless of the opening 536, 537, the openings may be coupled to the wastewater storage tanks or public utilities either via gravity-fed tubing or with the use of pumps for moving the wastewater from the consumer 120 to the wastewater storage tanks or public utilities.

The electrical interfaces 533, 533a of FIGS. 5A and 5B include a variety of electrical outlets (e.g., one or more 30A 120 VAC outlets 551, a 50A 220 VAC outlet 552, and 20A 120 VAC outlets 553) and other telecommunications outlets (e.g., cable TV outlet 561, telephone outlet 562, and Internet network outlet 563) arranged on an electrical panel 558. The kiosk 502 of FIG. 5C may also include an interface panel (coupled to, or part of, the ecommerce interface 115) for the consumer 120 to confirm a reservation, purchase selected utilities, and otherwise engage with the kiosk system 100. As discussed herein, the consumer 120 may also communicatively interface with the kiosk system 100 via a wireless connection with their cell phone or other portable computing device.

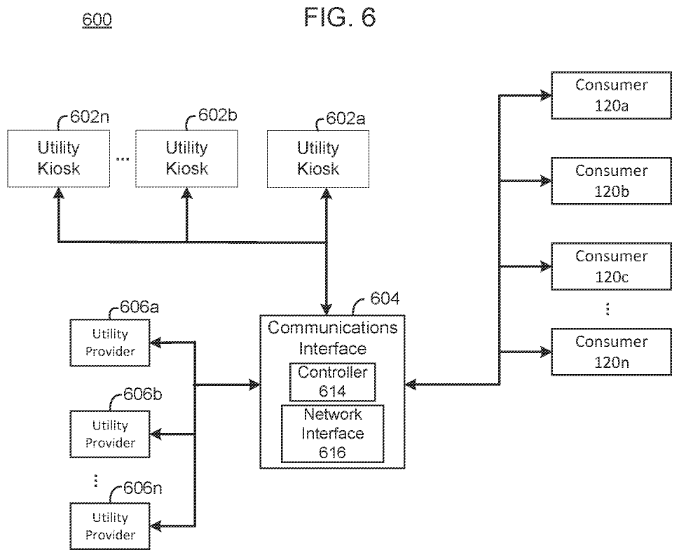

FIG. 6 is an exemplary utility kiosk interface system 600. The utility kiosk system 600 includes a plurality of individual utility kiosks 602a-n. The utility kiosks 602a-n can be any of the utility kiosks 100a-d discussed herein and illustrated in FIGS. 1-4. Each of the utility kiosks 602a-n is communicatively coupled to a central communications interface 604, which is communicatively coupled to a plurality of consumers 120a-n. The communications interface 604 includes a controller 614 for managing communications from the individual utility kiosks 602a-n and reservation requests coming from any number of the consumers 120a-n. The communications interface 604 includes a network interface 616 for managing/enabling the communications between the consumers 120a-n and the utility kiosks 602a-n. As illustrated in FIG. 6, the communications interface 604 is also communicatively coupled to a plurality of utility providers 606a-n, with the controller 614 managing utility provisioning requests/status reports between the utility providers 606a-n and the communications interface 604 (via the network interface 616).

The network interface 616 includes the necessary hardware and associated software to enable a variety of different telecommunications connections between the communications interface 604 and the consumers 120a-n, the utility kiosks 602a-n, and the utility providers 606a-n. Exemplary telecommunications hardware in the network interface 616 includes, for example, landline telecommunications, wireless telecommunications (e.g., cellular telecommunications, satellite telecommunications, and other wireless technologies), and Internet connections. Such telecommunications hardware provides for a communication coupling between the consumers 120a-n, the utility kiosks 602a-n, and utility provider 606a-n, and the communications interface 604, to provide for reservation requests and/or updates, kiosk status reports to the communications interface 604, and utility provider 606a-n status updates, reprovisioning requests, and utility requests by the utility kiosks 602a-n via the communications interface 604.

For example, an exemplary consumer 120a-n (via a mobile application and/or Internet based browser application) communicates with the communications interface 604 (via the network interface 616) to request a reservation at a particular utility kiosk 602 (e.g., kiosk 602a). In submitting a reservation request to the communications interface 604, reservation data is transmitted from the communications interface 604 to the kiosk 602. The reservation data can include services provided by the kiosk of interest, availability. Alternatively, the communications interface 604 can provide a reservation availability list or map to the consumer 120 that indicates which kiosks 602a-n have the requested utility services and the availability. The communications interface 604 can provide a list of available utility services and/or allow the consumer 120 to indicate the desired utility services (e.g., potable water, electricity, sewage services, telecommunications services, and other utility services).

The communications interface 604 (via the network interface 616) maintains a database of utility services that each kiosk 602a-n provides. The communications interface 604 is also able to receive utility provisioning requests from individual kiosks 602a-n (e.g., fuel, potable water, and sewage storage tank emptying) and forward those requests on to relevant utility providers 606a-n. Alternatively, the communications interface 604 may also monitor the utilities provided by the different utility kiosks 602a-n and request utility services from relevant utility providers 606a-n when their utility levels reach selected thresholds. For example, the utility providers 606a-n may include any one or more of potable water, sewage tank emptying, telecommunications providers, and additional electrical supply services, etc. The utility providers 606a-n may also include public utilities as well as private utilities.

While the consumers 120 of the utility services have been described as recreational vehicles (RV) or temporary residences but may also include a variety of different temporary utility service consumers. Such as, emergency vehicles providing emergency services, with the utility kiosk 602 a temporary unit (implementing any of the utility kiosks 100a-d discussed herein) that is movable to the emergency site. Alternatively, the temporary utility kiosk 602 may be placed along with temporary housing (e.g., temporary housing due to acts of nature, temporary public events, and civil unrest). Additional uses of a utility kiosk 602a-n are found at conventional vehicle service providers (e.g., truck stops, rest stops, and similar locations) providing utility services to semitruck vehicles, RVs, and other mobile consumers.

Thus, a utility kiosk 100a-d provides a variety of utilities to a consumer 120. The utility kiosk 100a-d is arranged as a self-contained system (“off-grid”) or configured to couple to publicly provided utilities (e.g., water, sewer, and electric). Alternatively, the utility kiosk 100 may be configured as a hybrid system with some utilities provided internally (e.g., a self-contained water tank with potable water and a self-contained storage tank for receiving and storing grey water/black water), while other utilities are provided by public utilities (e.g., electricity). The utility kiosk 100a-d also includes an e-commerce module allowing the consumer 120 to purchase selected utility from a particular utility kiosk 100a-d. The utility kiosk 100a-d also includes a communications module 116 for communicating with a central communications interface 604 for coordinating reservations by consumers 120, and scheduling utility provisioning requests to utility providers 606a-n.

Changes and modifications in the specifically described embodiments can be carried out without departing from the principles of the present invention which is intended to be limited only by the scope of the appended claims, as interpreted according to the principles of patent law including the doctrine of equivalents.

1. A utility provisioning station for providing utility services to a consumer, wherein the utility provisioning station comprises:
utility services for a consumer; and
a communications/control module comprising:
an ecommerce interface configured to receive a request from the consumer for one or more utility services; and
a controller configured to control the supply of utility services by the utility provisioning station, and to selectively provide utility services to the consumer.

2. The utility provisioning station of claim 1, wherein the utility services comprise at least one of:
a power supply configured to supply electrical power service to the consumer;
a water storage tank configured to retain water and supply water service to the consumer; and
a sewage storage tank configured to provide wastewater services by receiving and retaining wastewater from the consumer.

3. The utility provisioning station of claim 2, wherein the power supply comprises an energy storage module comprising at least one battery.

4. The utility provisioning station of claim 3, wherein the power supply comprises a solar panel array and/or a generator configured to produce electrical power and to supply electrical power to the energy storage module.

5. The utility provisioning station of claim 2, wherein the water storage tank comprises a water pump configured to selectively pump the water from the water storage tank to the consumer.

6. The utility provisioning station of claim 2, wherein the sewage storage tank comprises a wastewater pump configured to selectively pump wastewater from the consumer to the sewage storage tank.

7. The utility provisioning station of claim 1, wherein the communications/control module further comprises a communications module configured to provide telecommunications services to the consumer.

8. The utility provisioning station of claim 1, wherein the telecommunications services comprises at least one of telephonic services and Internet access.

9. The utility provisioning station of claim 1, wherein the consumer is one of a recreational vehicle, a temporary residence, and an emergency service vehicle.

10. The utility provisioning station of claim 1, wherein the ecommerce interface is configured to receive electronic payment as part of a request for selected utility services.

11. The utility provisioning station of claim 1 further comprising a utilities interface for delivering the utilities services.

12. The utility provisioning station of claim 11, wherein the utilities interface includes a security housing for securing access to the utilities services.

13. A utility kiosk interface system for coordinating the supply of utility services from a plurality of utility kiosks to a plurality of requesting consumers, wherein the system comprises:
a plurality of utility kiosks, each configured to provide one or more utility services;
a communications module communicatively coupled to each of the plurality of utility kiosks, the communications module comprising a network interface configured to communicatively couple to a plurality of consumers, and a controller configured to manage communications between the plurality of consumers and the plurality of utility kiosks; and
a plurality of utility providers, each configured to provide at least one utility service to at least one of the utility kiosks;
wherein the communications module is configured to manage utility service requests and/or utility reprovision requests from one or more utility kiosks to the plurality of utility providers; and
wherein the communications module is configured to manage utility service requests from any one or more of the plurality of requesting consumers, and configured to manage the reservation of utility services from a particular utility kiosk for a particular consumer.

14. The system of claim 13, wherein the utility kiosk comprises one of: a utility provisioning device arranged as a self-contained system (“off-grid”), a utility provisioning device coupled to publicly provided utilities (“on-grid”), and a utility provisioning device configured as a hybrid system with some utility services provided internally (“off-grid”), while other utility services are provided by public utilities (“on-grid”).

15. The system of claim 13, wherein the consumer is one of a recreational vehicle, a temporary residence, and an emergency service vehicle.

16. The system of claim 13, wherein the one or more utility services comprise at least one of:
a power supply configured to supply electrical power service to the consumer;
a water storage tank configured to retain water and supply water service to the consumer; and
a sewage storage tank configured to provide wastewater services by receiving and retaining wastewater from the consumer.

17. The system of claim 13, wherein the communications module comprises a network interface configured to communicatively couple the communications module to the consumers, the utility kiosks, and the utility providers.

18. The system of claim 17, wherein the network interface comprises telecommunications hardware comprising at least one of cellular telecommunications hardware for communicatively coupling to a cellular network, satellite telecommunications hardware for communicatively coupling to a satellite communications network, landline telephone technology, and Internet connections.
